(19) United States
(12) Patent Application Publication
(10) Pub. No.: US 2004/0251420 A1
(43) Pub. Date: Dec. 16, 2004

(54) X-ray detectors with a grid structured scintillators

(76) Inventor: Xiao-Dong Sun, Fremont, CA (US)

Correspondence Address: CHARLES QIAN, 1018 CRANBERRY DR, CUPERTINO, CA, 95014, US

(21) Appl. No.: 10/866,408

(22) Filed: Jun. 12, 2004

Related U.S. Application Data
(60) Provisional application No. 60/478,500, filed on Jun. 14, 2003.

(51) Int. Cl. G01J 1/00; G01T 1/24; G01T 1/20

(52) U.S. Cl. 250/370.09

(57) ABSTRACT

Method, components, design and fabrication process of a advanced X-ray flat panel detector (FPD), with built-in anti-scattering grid to reduce the X-ray scattering are disclosed. We further disclose two methods in the new X-ray detector: In the first method, the grid is placed on top of X-ray scintillator layer of a FPD, the pixels of X-ray FPD underneath are aligned with the hole structures of anti-scatter grids. The high performance anti-scatter grid applied and aligned to the flat panel detector (FPD) pixel-by-pixel can significantly reduce the noise from the scattered X-rays. The key advantages of the improved art are substantial reduction of grid shadow, improved image contrast-to-noise ratio (CNR) and minimized attenuation of direct X-rays. The new FPD with built-in grid may significantly enhance X-ray imaging system performance for a FPD based digital detection system with high image quality, high throughput and low cost for many X-ray imaging applications. In the second method, the grid may be fully or partially filled with X-ray scintillators and the combined sensor plate can be applied as X-ray sensor on a FPD. This plate integrates X-ray scintillator with anti-scatter grid. Using this scintillator plate on FPD, the key X-ray detector performances, such as image contrast-to-noise ratio (CNR), modulation transfer function (MTF), and detective quantum efficiency (DQE) may be improved significantly. The design of the detector plate allows flexible choices of the various scintillators to meet specific requirements of an X-ray imaging system, without sacrificing the detector performances such as the scattering X-ray rejection and MTF.

This application claims priority to the provisional application entitled “Advanced X-ray Detectors”, Ser. No. 60/478,500, filed by the same subject inventors and assignee as the subject invention on Jun. 14, 2003.

### BACKGROUND OF THE INVENTION

1. Field of the Invention

The present invention relates generally to X-ray detectors and more particularly to a system and a method for integrating an anti-scattering grid with scintillators to significantly enhance the performance of flat panel X-ray detector.

2. Background Art

Over the last several years, digital X-ray flat-panel detectors (FPD) based on the combination of amorphous silicon thin film transistor and photodiode with X-ray scintillators technology have been successfully developed by several major medical imaging equipment company (GEMS-PerkinElmer Optoelectronics Inc., Phillips-Varian-dPix and Hologic Inc. etc.). These digital detectors, in general, have much better dynamic range and detection quantum efficiency (DQE) than conventional X-ray films. Due to fast market growth of flat-panel based digital X-ray imaging systems and continuous improvement in large panel manufacturing technology and yield, performance-to-price ratio of FPD is improving rapidly.

The existing digital X-ray FPD technology can be divided into 2 categories: direct and indirect conversion. In direct conversion X-ray FPD (e.g., Hologic Inc.), Selenium (Se) photoconductor is used to directly convert X-rays into free electrons. Selenium detectors have very high Modular Transfer Function (MTF), but suffer low X-ray quantum efficiency (for X-ray energy >40 keV) and low X-ray absorption. It also has high image lag and low detection quantum efficiency (DQE) at low spatial frequencies. Most indirect conversion detectors use either CsI or Gd₂O₂S as X-ray scintillator and amorphous silicon photodiode array as light sensor. Indirect conversion detectors have high quantum efficiency (for X-ray photons above 40 keV), low image lag and high DQE at low spatial frequencies. However, the existing indirect X-ray FPD suffers low MTF and low DQE at high spatial frequency. The present invention provides an improvement on the existing indirect X-ray FPD by introducing a registered anti-scatter grid in the FPD, resulting structured scintillators in registry to pixels of underlying photon detector array in FPD. The improvements will significantly reduce X-ray scattering and improve the MTF and DQE of existing indirect digital X-ray FPD.

There are several key challenges in building a high performance FPD for medical X-ray diagnostic imaging applications. One of the challenges is the need for higher resolution and higher sensitivity with the FPD for imaging small bones and soft tissues. There is a continues improvements by various major manufactures of medical systems (e.g. Perkin Elmer, Varian, GE) to enhance resolution. The other challenge is the reduced image contrast of scatter-to-direct X-rays, which is a serious issue particularly for Computed Tomography (CT) detector applications. The scattering issue needs to be resolved before the FPD may become a viable detector for some medical diagnostic imaging applications such as cone beam CT.

One current solution to prevent the scattered X-ray from being detected by FPD is to place an anti-scatter grid before the detector. Such a grid, placed outside of the FPD, blocks some undesirable scattered X-ray from entering FPD and contribute to noise. Andrew Smith et al., disclosed a X-ray detection structure that placed an antiscatter grid on direct conversion X-ray flat panel detector (U.S. Pat. No. 6, 282,264 or “264”). The grid, made in thin strips (laminae, Column 15, line 32) of radio opaque material, is placed above the flat panel detector to reduce the X-ray scattering into the detector (FIG. 60 of “264”). Such external use of anti-scatter grid with a FPD attenuates X-ray into the detector and generate problem such as Moire Pattern on the FPD (column 17, line 1). There is no X-ray scintillator used in the direct conversion FPD of “264”.

Cha-Mei Tang disclosed the use of a “radiation mask” on indirect X-ray FPD with scintillator (U.S. Pat. No. 6,272,207, or “207”). The mask is placed between the X-ray radiation source and the detector (column 5, line 33) or between the object and the detector (column 5, line 43). In FIG. 1, the use of the mask on the flat panel detector in “207” for X-ray or Gamma ray detection is illustrated. The mask 103 is placed on the upper surface of the scintillator 104 (column 9, line 6). Each aperture of the mask is aligned with a corresponding pixel of the detector 105. It is claimed that with the mask the detector system MTF can be improved.

The use of grid will substantially attenuate the direct X-ray hence additional X-ray exposure becomes necessary to obtain a certain signal level. This effect is partially caused by the shadowing effect of the mask or grids on the scintillator underneath it.

In general, the higher the grid aspect ratio, the smaller the scatter-to-primary ratio, and the better image quality are obtained. However, there are tradeoffs: Increasing the grid aspect ratio can cause several issues due to factors such as manufacturing defects, grid misalignment with detector and tight X-ray focus requirement. These issues, in addition to the decreasing transmission of direct X-rays due to casting grid shadow in the images etc., are serious concerns when coupled with FPD for imaging applications. One example is that the mismatch of grid and detector pixel can easily cause periodic grid shadows (aliasing effect) in digital images not visible on X-ray films (due to low sensitivity of human eye), but severe artifact in 3-D reconstructed images due to high sensitivity of CT reconstruction algorithm. In another example, because the detection quantum efficiency (DQE) of commercial FPD drops significantly at low dose (<10 mR) of X-ray exposure, too much absorption of direct X-ray by anti-scattering grid can easily put the detector operation point below its optimal and lead to poor quality images. Indeed several comparative studies from several groups of physicians have shown that the existing way to use the anti-scatter grid does not help the image quality of digital radiography¹(with Se direct conversion FPD) or digital mammography² and are not recommended. ¹“Digital Selenium Radiography: anti-scatter grid for chest radiography in a clinical study” Bernhardt T M, etc., Britsh Journal of Radiology Vol. 73(873): 963-968, 2000 ²(a) “The value of scatter removal by a grid in full field digital mammography” Veldkamp W J H, etc. Medical Physics Vol. 30(7):1712-1718, 2003; (b) “X-ray scattering in full field digital mammography” Nykanen K, Siltanen, S. Medical Physics Vol. 30(7): 1864-1873, 2003

### SUMMARY OF THE INVENTION

We disclose methods, components, design and fabrication process of advanced X-ray flat panel detectors (FPD) with built-in anti-scattering grid to reduce the scattering X-ray into detector and improve the detective image quality.

We further disclose two methods in the new X-ray detector: In the first method, the grid is placed on the top surface of the X-ray scintillator layer of the FPD, the pixels of X-ray FPD sensor underneath are aligned with the hole structures of anti-scatter grids.

In the second method, the grid may be fully or partially filled with X-ray scintillators and the combined sensor plate may be applied as X-ray sensor on a FPD. This plate integrates X-ray scintillator with anti-scatter grid for improved detective performance.

In addition, multiple pieces of such scintillator filled detector plate may be stacked or combined in a single unit of FPD, to provide multiple structured scintillators and extend or tailor the detective energy spectrum of the absorbed X-ray photons, which offers the detection flexibility for X-ray and gamma ray. Various scintillator materials may be introduced into grids and combined in various sequences for advanced X-ray detection.

The process for prepare such scintillator filled grid plate includes but not limited to thin film vapor deposition, electroplating, and centrifuging, Either High transmission cellular (HTC) or metal machined grid will be used, with various choices of metal and alloys as grid materials.

The FPD with built-in pixel aligned with anti-scatter grid on the scintillator surface can be applied in an X-ray or gamma ray imaging system for image detection, including cone beam CT application.

The FPD with single or multiple layers of scintillator filled built-in grid can also find applications in an X-ray or gamma ray imaging system to for image detections, including cone beam CT application.

Such structured scintillator plates can be combined with various flat panel light sensors including photodiode array, CCD, or CMOS sensors for advanced X-ray and gamma ray detection.

Such FPD with advanced structured scintillator plates or built-in pixel aligned anti-scatter grid can be used in medical diagnosis, non-destructive image evaluation; security inspection, etc.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 illustrates a prior art use of an external mask on X-ray detector;

FIG. 2 shows the structure of an integrated FPD with built-in anti-scattering grid;

FIGS. 3a and 3b show the simulation results on the attenuation of scattered X-ray at various angles with 3 different metal grids (W, Mo, Cu);

FIG. 4 illustrates the cross-section of the high performance X-ray sensor plate with scintillator-filled anti-scattering grid;

FIG. 5 illustrates the cross-section of the high performance X-ray sensor plate with multiple layers of various scintillator-filled anti-scattering grids;

FIG. 6 illustrates the fabrication process flow of structured scintillator plate;

FIG. 7 illustrates an X-ray imaging system containing X-ray tube and the new structured scintillator anti-scattering grids in FPD;

FIG. 8 illustrate an X-ray imaging system combining the X-ray scintillator plate and CCD sensor.

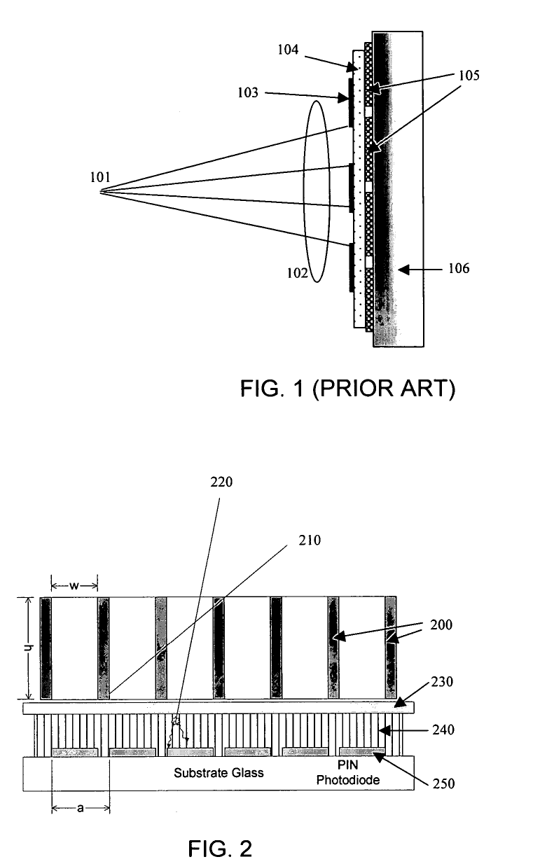

### DETAILED DESCRIPTION OF THE INVENTION

We disclose an integrated flat-panel X-ray or gamma ray detector with built-in pixel-registered anti-scattering grid to further improve the X-ray FPD. Furthermore, scintillator is filled into the openings of the built-in anti-scattering grid to form a combined X-ray detector plate for the detection of X-ray or gamma ray.

1. Built-In Pixel-Aligned Anti-Scattering Grid In Indirect X-Ray Flat Panel Detector (FPD)

The anti-scattering grid or collimator needs to be carefully selected and matched with flat-panel detector array to achieve best overall system performance. We disclose an integrated flat-panel detector with pixel registered anti-scattering grid. The schematic of our disclosed flat panel X-ray detector with anti-scatter grid (200) design is shown in FIG. 2. The anti-scattering grid is customized and aligned to the flat panel detector pixel-by-pixel. The built-in grid has a certain thickness aspect ratio to block scattered X-ray (210) from entering the FPD while allowing the straight X-ray (220) meet the FPD. In this structure, Csl was used as scintillator and sealed by a scintillator cover from direct exposure to the built-in grid. The key advantages are: it can significantly reduce the grid shadow concern, improve detector MTF (therefore DQE at high spatial frequency), and minimize attenuation of direct X-rays.

a. Anti-Scatter Grid Selection

There are several types of anti-scatter grids that can be applied in our integrated grid FPD. The following is a brief summary of the grids that can be used in our FPD:

a. High Transmission cellular (HTC) grid

HTC grid shown is a crosshatched anti-scatter grid made of beryllium copper or tungsten using micro-fabrication technology (chemical etching metal plate patterned with photolithography process. Tungsten is a very good material for grid with very efficient attenuation to scattered X-rays with energy from 20 keV to 120 keV. Beryllium copper has lower X-ray absorption than tungsten. For mammography applications, beryllium grid is acceptable. However, for CT applications, tungsten can be our first choice. The availability of various metal grids allows us to optimize and validate our grid model, study and understand the impact of grid geometry, manufacturing technique to detector performance.

HTC grid can be easily customized to match the pixel size and array dimension of the flat-panel detectors since it uses photolithography process to pattern the grid. To eliminate grid artifacts such as Moire pattern, HTC grid needs to be precisely aligned with the pixel pattern of underneath detector. For long term stability, the grid plate (after filled with X-ray or Gamma ray scintillating material) needs to be bonded to the FPD.

b. Machined Grid

The typical aspect ratio of such grid varies from 5:1 to 15:1. Various metals can be used, for example, using Pb/Bi alloy as X-ray absorber. The grid can be made using diamond saw to cut into a substrate material. The process can yield uniform grid spacing over a large area. However, the linear grid cannot absorb scattered X-ray in the parallel direction to the cut. To achieve isotropic attenuation of scattered X-ray, we can stack two linear grids placed perpendicular to each other. Advantage of such grid is that, the grid aspect ratio can be made very high since it is the sawing process controls height. Its cost is also much lower than HTC grid. Its major drawback is that the grid is not X-ray focused; attenuation to direct X-rays increase with grid size.

To summarize, the followings are the desirable properties of the grids in our FPD:

(a) High grid ratio and low direct X-ray absorption

(b) Grid pitch matches flat-panel detector pixel array; grid focal length also matches the X-ray tube configuration of the cone beam CT system

(c) Uniform grid across whole detector array

(d) Thermal expansion coefficient matches or is close to the cover of the detector scintillator

(e) Mechanical stiffness

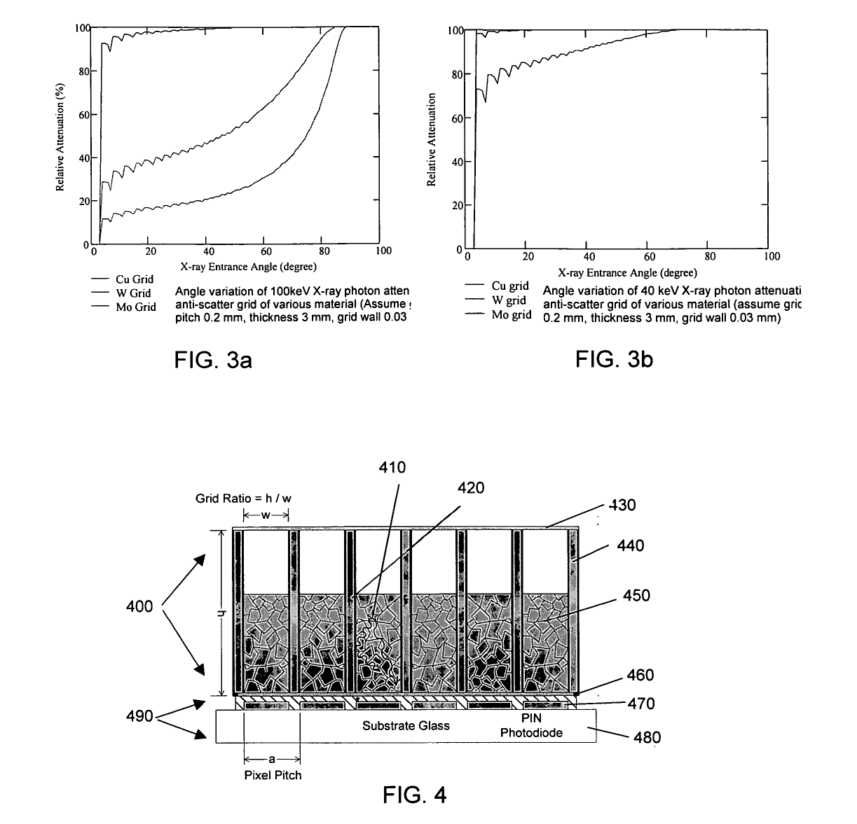

We have performed mathematical simulation on the effect of the built-in pixel-registered anti-scattering grid in attenuation of scattered X-rays, on several different grid materials (Tungsten, Mo, Cu). To match the pixel structure of the commercial FPD detector, the predefined grid pitch is 0.2 mm, thickness 3 mm, grid wall 0.03 mm. FIG. 3 shows our simulation results for (a) high energy X-ray (100 keV) and (b) low energy (40 keV) X-ray. Tungsten grid is the most effective in allowing only direct (angle˜0degree) 100 keV X-ray to pass and block most scattered X-rays (>80%). And Cu grid suffice to block most of the scattering 40 keV X-ray from entering the detector. Our simulation indicates that a built-in pixel-matched grid in FPD is highly effective in reducing the scattering X-ray and improve the X-ray imaging system performance.

2. Built-in Grid with Filled in-Scintillator as the Sensor Plate for FPD

A new approach is disclosed herein to combine an integrated anti-scattering grid, advanced X-ray scintillator, and photon isolation grid together to form a high performance X-ray scintillator plate. Theoretical study indicates that, when the grid is matched to the FPD, the plate can eliminate up to 80% of scattered X-rays; it also improves the MTF to match performance of a direct conversion detector for X-ray of both low and high energy; finally, it allows the flexible use and choice of better scintillators with higher X-ray photon absorption and quantum conversion than that of Csl in existing indirect FPD. Applying this improvement to current FPD, detector performance, such as DQE, MTF, CNR (contract to noise ratio) can be dramatically enhanced; and low cost but high quality FPD based medical diagnostic CT system may become reality.

a. Single-layered Grid Plate filled with Scintillators

FIG. 4 shows schematically the design of high performance scintillator plate (400) with build-in anti-scattering grid (440) coupled to a flat panel digital X-ray detector (490). A commercial digital photo detector (e.g. photodiode array, CCD, CMOS) can be used. This detector has a pixel pitch of 200 μm (output is binned to 400 μm) and total 1024×1024 pixels. The pitch of the anti-scattering grid matches the detector for optimum performance. For maximum attenuation to X-rays above 50 keV, high Z metal needs to be used for the grid. To minimize absorption of visible photons, the inner wall of the anti-scatter plate is coated with high reflection metal and protective films (not shown). The grid is filled with scintillator material (450) to a thickness dependent upon requirement of total X-ray conversion factor. The thickness of the scintillator plate is determined by the anti-scattering grid thickness, which is, again, determined by the requirement of attenuation to scattered X-rays and X-ray absorption coefficient of the grid material. The top of the plate is a window transparent to X-rays (430, a plate made of graphite or thin aluminum); the bottom is a glass plate with high light transmission coefficient and matched index with the X-ray scintillator. While the grid blocks the scattered X-ray (420) from meeting the detector, the filled scintillator will be exposed to direct X-ray (410) with less shadowing effect, hence the image contrast can be maintained without much increase of X-ray exposure.

We can use similar commercial grid plate as described earlier—HTC plate and machined grid plate here. Unlike epoxy grid, the thermal expansion coefficient of the metal grid (e.g. Mo) matches closely to the underneath flat panel amorphous silicon photodiode array; thus the metal grid provides superior pixel alignment accuracy and reliable performance over its lifetime. One of the biggest advantages of HTC grid is that the grid is focused to a point X-ray source. The focus length could be specified by custom requirement. This design offers significantly better uniformity of scatter-to-direct ratio, and better utilization of primary X-ray photons across the entire anti-scatter gird than that of the non-focused grids. The grid plate can be made of metal alloy also to improve its X-ray attenuation efficiency and match its thermal expansion coefficient with substrate material of the FPD.

Since HTC grid is manufactured using photolithography process, this allows us to specify the anti-scatter grid with geometric dimension matching exactly to the FPD. In addition, the geometric shape of grid cell can also be easily varied. The grid formats can be linear, square and circular shape grid.

b. Multiple-layered Grid Plates Filled With Combination of Different Scintillators

Different single-layer scintillator plates can be combined together to form a composite scintillator plate. Each layer may have different X-ray scintillator material. For example, one layer scintillator is highly efficient to low energy X-ray, another is for high energy X-rays; when the two layer are stack together, the composite scintillator plate can be used for dual-energy X-ray diagnostic imaging or any NDT applications.

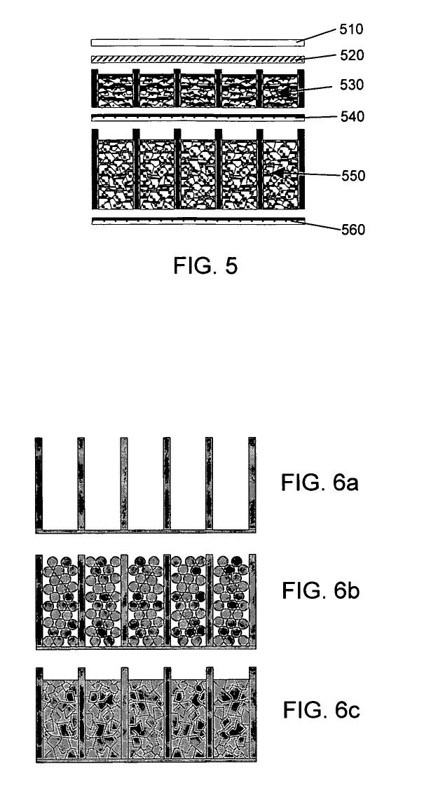

FIG. 5 shows the schematics of the multiple layers X-ray scintillator plate with built-in anti-scatter grid. Our high performance scintillator plate has very flexible choices of manufacturing approaches and materials for the grid walls. The disclosed scintillator structure is made of heavy metals (e.g., Tungsten) and coated with highly reflective metal and dielectric films for environmental stability and stiffness. Scintillator, after filled into the cell, can be annealed to improve X-ray conversion efficiency and visible photon transmission. The process to make the plate does not require expensive and large size dry etch equipment (e.g. RIE), therefore it offers much better performance vs. price ratio.

The advanced scintillator plate offers the following unique features and advantages:

The grid is made of high Z material, such as tungsten, to attenuate more than 80% of scattered X-rays from 20 to 120 keV.

Visible photons are generated and confined inside individual cells of the grid, which is registered with the photodiode on the flat-panel imager. The overall MTF of the detector is close to the theoretical value of the pixel Sinc function

The scintillator plate can be readily customized to fit various types of detectors. For example, using small pitch anti-scatter grid (˜40 μm) with fast responding scintillator material such as, Gd₂O₂S:Pr, Ce, the plate can be coupled to a fast readout CMOS or CCD image sensor to form a high speed digital X-ray detector for a high resolution CBCT. Such a system can offer significantly improved X-ray imaging performance and more detection flexibility than existing ones which use mostly Kodak Lanex scintillator plate or Hamamatsu fiber optic scintillator plate.

Furthermore, multiple scintillator materials can be used to fill the grid layer bi-layer to extend or tailor the energy spectrum of the absorbed X-ray photons.

The scintillator can have better X-ray photon conversion efficiency than Csl based detectors since Gd₂O₂S:Tb has higher X-ray luminosity (>15%) and much higher X-ray absorption. X-rays absorbed by the grid is typically less than 10%. (Depending upon fill-factor of the grid). Also, since each pixel is optically isolated, the scintillator can be made as thick as to absorb 100% of all incident X-ray photons.

In summary, the new X-ray detection plate with built-in anti-scattering grid filled with scintillators significantly improves the performance of current X-ray imaging systems. Advanced FPD with high X-ray luminosity (or fast response), high MTF and high ratio of direct-to-scattered X-rays can be achieved simultaneously without compromise.

C. X-ray Plate Fabrication Process Development

The fabrication process of the disclosed X-ray scintillator plate is illustrated in FIG. 6. First, the anti-scatter grid can be thoroughly cleaned, with a combination of H₂O₂, HF, and HCl, and intermittent de-ionized water rinsing to degrease and decontaminate the grid surface. The cleaned grid may be coated with heavy and high reflective metal such as silver or tungsten (W) using in-house magnetron DC-sputter deposition technique. The grid can be rotated during deposition to obtain more uniform coating. To eliminate the possible “shadowing” effect in the sputter deposition with the high aspect ratio grid, we can apply an established CVD (chemical vapor deposition) process to conformally coat the grid surface with heavy metals such as tungsten. For example, tungsten hexafluorides can be reduced by hydrogen at a temperature of 300 to 500° C.³ to deposit W metal. The heavy metal coating cost can be further reduced in the future manufacturing of the X-ray plate products, by well-established Ag electroplating process. (FIG. 6a)

To deposit scintillator particles into the treated anti-scatter grid and prepare a well-packed X-ray detector plate, we can apply a simple but powerful centrifuging process to force scintillator particles from a liquid suspension into the grid cells. We can put the treated grid (e.g. 1 inch by 1 inch) into a bucket or insert of a general-purpose centrifuge, load the liquid suspension with a certain amount of scintillator for desirable scintillator thickness in the detector. The container can be mounted into the swing-out rotor of the centrifuge, and centrifuge speed as high as 17,000 RPM can be obtained with the commercial available centrifuge, which can create extremely high ³ Handbook of Chemical Vapor Deposition, Principles, Technology and Applications, by Hugh O. Pierson, Noyes Publications, 1992centrifuge force (>20,000×gravity) perpendicular to the plate to pack the suspended scintillator of ˜1-5 microns in size into the cells with high density. Since all the cells in the grid experience identical centrifuging force with exposure to the same suspension, we expect the filling and packing thickness of scintillators can be highly uniform in the plate. This process can also be repeated with different batches of scintillator suspensions to deposit multiple layers of different polycrystalline scintillators into the anti-scattering grid. (FIG. 6b)

The packed plate can be taken out of the container, dried in oven, and annealed in furnace to re-crystallize the well-packed scintillator particles to further improve the X-ray convention efficiency (FIG. 6c). The additional advantage of this process is that it can work with any X-ray scintillator material in preparing its well-packed anti-scattering column structure for high performance X-ray detectors. For example, we can use the excellent GOS scintillators which include highly efficient Gd₂O₂S:Tb and Gd₂O₂S:Pr,Ce. Initially, we can use a 1×1 inch² anti-scatter plate already commercially available to develop and optimize the process; and characterize and test the performance of the scintillator plate on the PerkinElmer RID 512 detector.

3. X-Ray Imaging System with the New FPD and Grids

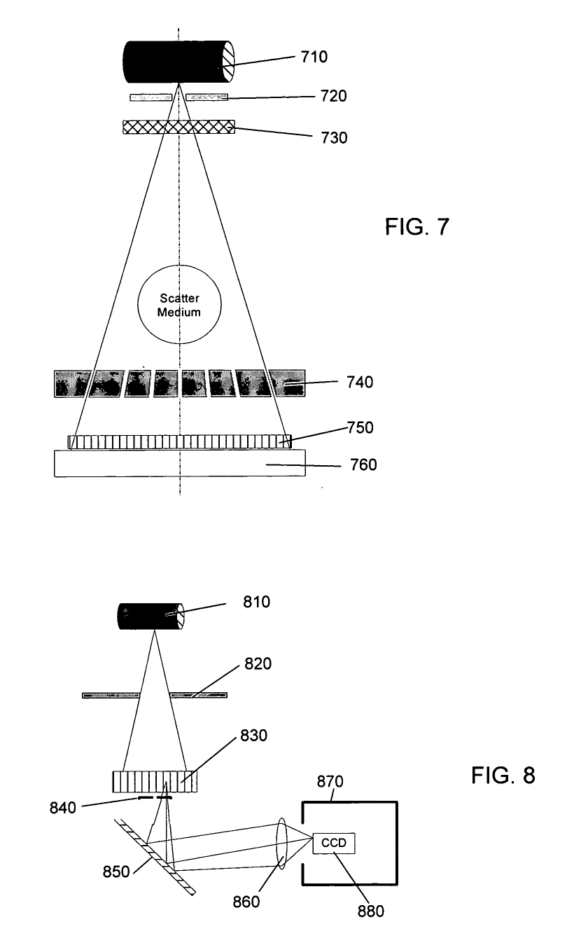

FIG. 7 shows the schematic of a typical X-ray imaging system setup using our new FPD and anti-scattering grids. Although shown in FIG. 7 is a vertically mounted system, it is also possible to setup the system horizontally on an optical bench. The key component of the setup is the FPD (760), which can be used both for efficiency measurement of the anti-scatter grid and for system performance measurement such as DQE, MTF, noise etc. A custom-made direct X-ray collimator (740) can be used for measurement of the distribution of direct X-ray dose on the detector. The collimator is hold by a slider for easy insertion and removal from the X-ray beam path; its focus is carefully adjusted to match the X-ray tube (710) position. Between X-ray tube (710) and FPD (760) is the scatter medium, which can easily be replaced by a rotational stage with a phantom for converting the system into a cone beam CT system. Various X-ray filters (730) may be used to achieve uniform X-ray intensity at the detector. The source diaphragm (720) is to set the cone-beam angle to match the detector area. For certain application, the anti-scatter grid can be mounted on a X-Y stage controlled by a computer. The precision motion control of the grid allows the operator to find the optimal position to minimize grid artifacts.

Such disclosed setup can be converted into a simple laboratory CT by installing a rotation stage to hold a 3D phantom. A standard Feldkamp cone-beam CT reconstruction algorithm or other advanced Cone beam CT algorithm can be used to process all acquired projection image to reconstruct a 3-D image of the phantom.

FIG. 8 shows a preferred setup of the scintillator plate in a X-ray imaging system. The X-ray imaging system consists of an X-ray tube (810), a lead window (820) for X-ray beam size control, an X-ray dosimeter, the X-ray plate, and a CCD camera (880). The CCD is focused on the backside of the scintillator plate (830) to be tested. CMOS plate can also be combined with the new structured scintillator sensor plate for X-ray detection applications.

4. Scintillator Plate in Other High Energy Particle Imaging System

Application of scintillator plate is NOT LIMITED to X-ray imaging systems; it may also be used for other type of high-energy particle imaging systems (including Gamma-ray imaging system). For example, using scintillator such as BGO (Bi₄Ge₃O₁₂) to fill the grid and plate on top of a flat-panel photo-diode array, the detector becomes a gamma-ray camera for high performance nuclear medicine detection applications.

It will be apparent to those with ordinary skill of the art that many variations and modifications can be made to the system, method, material and apparatus of structured scintillator based indirect X-ray detection disclosed herein without departing form the spirit and scope of the present invention. It is therefore intended that the present invention cover the modifications and variations of this invention provided that they come within the scope of the appended claims and their equivalents, we claim:

1. A X-ray or gamma ray sensor plate comprising:
at least one region of grid partially filled with scintillating material;

2. The sensor plate recited in claim 1 wherein the said grid being made of metallic materials.

3. The sensor plate recited in claim 1 wherein the said grid being covered with metallic coating or dielectric coatings.

4. The sensor plate recited in claim 1 wherein the said region of grid having grid spacing of 1 pm to 10 mm; or preferably of 10 μm to 1 mm.

5. The sensor plate recited in claim 1 wherein the said scintillating material being in powder form.

6. The sensor plate recited in claim 1 wherein the said scintillating material being in the form of a coating or thin film.

7. The sensor plate recited in claim 1 wherein the said scintillating material being rare earth doped Gd₂O₂S.

8. The sensor plate recited in claim 1 wherein two or more scintillating material filled grids being stacked together forming a multiple layered X-ray or gamma ray sensor plate.

9. An indirect flat panel X-ray or gamma ray detector comprising:
at least one sensor plate having at least one region of grid partially filled with scintillating material;
at least one flat panel detector containing at least one array of photo detector.

10. The detector recited in claim of 9 wherein the said photo detector being amorphous silicon photodiode.

11. The detector recited in claim of 9 wherein the said photo detector being polycrystaline silicon photodiode.

12. The detector recited in claim of 9 wherein the said photo detector being an charge coupled detector (CCD).

13. The detector recited in claim of 9 wherein the said photo detector being an complementary metal-oxide semiconductor (CMOS).

14. An indirect flat panel detector for X-ray or gamma ray comprising:
an array of optical detectors with a regular spacing in between;
a grid structure with substantially identical spacing being aligned with the said optical detectors;
a layer of scintillating material being attached atop the said photo detectors;

15. The flat panel detector recited in claim 14 wherein the said grid being made of metallic materials.

16. The flat panel detector recited in claim 14 wherein the said grid being covered with metallic coating.

17. The flat panel detector recited in claim 14 wherein the said grid structure having grid spacing of 1 μm to 10 mm; or preferably of 10 μm to 1 mm.

18. The flat panel detector recited in claim 14 wherein the said scintillating material being rare earth doped Gd₂O₂S.

19. The flat panel detector recited in claim 14 wherein the said scintillating material being TI doped Csl.

20. The flat panel detector recited in claim of 14 wherein the said optical detectors being amorphous silicon photodiodes.

21. The flat panel detector recited in claim of 14 wherein the said optical detectors being polycrystaline silicon photodiodes.

22. The flat panel detector recited in claim of 14 wherein the said optical detectors being charge coupled device.

23. The flat panel detector recited in claim of 14 wherein the said optical detectors being complementary metal-oxide semiconductor.

24. An digital X-ray imaging system containing an X-ray source and the flat panel detector recited in claim of 9-23.

25. An gamma ray imaging system containing an gamma ray source and flat panel detector recited in claim of 9-23.
